(19) United States
(12) Patent Application Publication
(10) Pub. No.: US 2026/0329380 A1
(43) Pub. Date: Oct. 22, 2026

(54) METHOD, APPARATUS AND SYSTEM FOR GENERATING LOCAL VIBROTACTILE FEEDBACK AND COMPUTING DEVICE

(71) Applicants: BOE TECHNOLOGY GROUP CO. , LTD., Beijing (CN); PEKING UNIVERSITY, Beijing (CN)

(72) Inventors: Shuai WANG, Beijing (CN); Hangyu LI, Beijing (CN); Jijing HUANG, Beijing (CN); Dexing QI, Beijing (CN); Yongmao PEI, Beijing (CN); Yingzi WANG, Beijing (CN); Dongsheng HUANG, Beijing (CN); Li ZHOU, Beijing (CN)

(21) Appl. No.: 19/108,772

(22) PCT Filed: Sep. 19, 2023
(86) PCT No.: PCT/CN2023/119708

§ 371 Date: Mar. 5, 2025

(51) Int. Cl. G06F 3/01

(52) U.S. Cl. CPC G06F 3/016

(57) ABSTRACT

A method, apparatus, and system for generating localized vibrotactile feedback and a computing device are provided. The method includes: determining a set of eigenmodes and a set of reference modal participation coefficients associated with a vibration plate based on a target vibration position and a reference vibration field at the target vibration position; determining a target vibration field at the target vibration position based on the set of eigenmodes and the set of reference modal participation coefficients; selecting a subset of eigenmodes for modal superposition and its corresponding subset of modal participation coefficients based on the set of reference modal participation coefficients; and determining, based on the subset of eigenmodes and its corresponding subset of modal participation coefficients and a position of a vibration component, driving control information for driving the vibration component to generate the localized vibrotactile feedback at the target vibration position.

### TECHNICAL FIELD

The present application relates to the field of touch technology, and more specifically, to a method, apparatus, and system for generating localized vibrotactile feedback at a target vibration position of a vibration plate, and a computing device.

### BACKGROUND

Haptic feedback is one of the essential interaction channels to achieve immersive interaction. In addition to audio-visual interaction, virtual haptics may be integrated into various interactive media, such as mobile phones, tablets, vehicle-mounted displays, etc., which can greatly improve human-computer interaction experience. Haptic feedback is the basis of human-computer interaction interface design, blind assistant, game entertainment, and many other applications. In recent years, traditional haptic feedback technologies used for basic functions such as vibration reminders, press confirmations, and the like have developed along the direction of realizing more complex and fine tactile feedback effects, mainly including localized vibration and texture pattern reproduction.

Traditional vibrotactile feedback only achieves overall vibration and cannot achieve localized vibrotactile feedback with a smaller area, making it impossible to achieve more complex and fine tactile feedback effects. In addition, when achieving localized vibrotactile feedback effects based on high-frequency vibration or electrostatic friction regulation, frequencies may not be easily controlled to the frequency range where human tactile perception is most sensitive (for example, 50-500 Hz).

Therefore, there is a need for a device that can simultaneously achieve localized vibrotactile feedback and whose vibration frequencies are within the frequency range where human perception is most sensitive (for example, 50-500 Hz).

### SUMMARY

According to an aspect of the present application, there is provided a method for generating localized vibrotactile feedback at a target vibration position of a vibration plate, comprising: determining a set of reference modal participation coefficients corresponding to a set of eigenmodes associated with the vibration plate based on the target vibration position and a reference vibration field at the target vibration position; determining a target vibration field at the target vibration position based on the set of eigenmodes and the set of reference modal participation coefficients; selecting a subset of eigenmodes for modal superposition from the set of eigenmodes and determining a subset of modal participation coefficients corresponding to the subset of eigenmodes, wherein a superposed vibration field generated based on the subset of eigenmodes and its corresponding subset of modal participation coefficients satisfies a preset similarity requirement with the target vibration field; and determining driving control information based on the subset of eigenmodes and its corresponding subset of modal participation coefficients and a position of a vibration component at the vibration plate, wherein the driving control information is used to drive the vibration component to generate the localized vibrotactile feedback at the target vibration position.

According to another aspect of the present application, there is also provided an apparatus for generating localized vibrotactile feedback at a target vibration position of a vibration plate, comprising: a determination module configured to determine a set of reference modal participation coefficients corresponding to a set of eigenmodes associated with the vibration plate based on the target vibration position and a reference vibration field at the target vibration position, and determine a target vibration field at the target vibration position based on the set of eigenmodes and the set of reference modal participation coefficients; a selection module configured to select a subset of eigenmodes for modal superposition from the set of eigenmodes and determine a subset of modal participation coefficients corresponding to the subset of eigenmodes, wherein a superposed vibration field generated based on the subset of eigenmodes and its corresponding subset of modal participation coefficients satisfies a preset similarity requirement with the target vibration field; and a driving control module configured to determine driving control information based on the subset of eigenmodes and its corresponding subset of modal participation coefficients and a position of a vibration component at the vibration plate, wherein the driving control information is used to drive the vibration component to generate the localized vibrotactile feedback at the target vibration position.

According to another aspect of the present application, there is also provided a computing device, comprising: a processor; and a memory having stored thereon a computer program, which when executed by the above-mentioned processor, can perform the method for generating localized vibrotactile feedback at a target vibration position of a vibration plate as described above.

According to another aspect of the present application, there is also provided a system for generating localized vibrotactile feedback at a target vibration position of a vibration plate, comprising: a vibration plate provided with a plurality of vibration components; laser vibration measurement means for measuring a set of eigenmodes associated with the vibration plate; processing means for obtaining a reference vibration field at the target vibration position and the set of eigenmodes obtained by the laser vibration measurement means and performing the method for generating localized vibrotactile feedback at the target vibration position of the vibration plate as described above; and a driving circuit for generating and outputting a driving signal to drive the plurality of vibration components based on driving control information from the processing means, so that the plurality of vibration components vibrate the vibration plate.

With the examples of this application, a small number of eigenmodes are selected for superposition by similarity comparison between vibration fields for achieving localized vibrotactile feedback effects, thereby reducing the complexity of corresponding circuits and hardware as well as algorithm computation, and facilitating the implementation of complex (e.g., multi-point localized vibration), high-resolution (as small as 3 cm in area) tactile feedback effects. In addition, by appropriately selecting a hardware configuration of the vibration plate, envelope wave modulation can also be achieved, so that vibration frequencies may be within the frequency interval where human perception is most sensitive (for example, 50-500 Hz), thereby further improving the vibration effects.

### BRIEF DESCRIPTION OF DRAWINGS

Accompanying drawings illustrate various embodiments of aspects of the present application and, together with the description, serve to explain principles of the present application. Those skilled in the art will appreciate that specific embodiments shown in the drawings are exemplary only and not intended to limit the scope of the application. In the drawings:

FIG. 1 shows a schematic diagram of a system for generating localized vibrotactile feedback at a target vibration position of a vibration plate according to an embodiment of the present application.

FIG. 2 shows a schematic flowchart of a method for generating localized vibrotactile feedback at a target vibration position of a vibration plate according to an embodiment of the present application.

FIG. 3 shows a flowchart of a process of selecting a subset of eigenmodes in step S230 of FIG. 2.

FIG. 4 shows an algorithmic flowchart of a process of selecting a subset of eigenmodes in step S230 of FIG. 2.

FIG. 5 shows a schematic diagram of a frequency response obtained by a laser vibration measurement process.

FIG. 6 shows a table illustrating 42 eigenmodes identified by a laser vibration measurement process.

FIG. 7(a) shows a designed localized vibrotactile feedback effect as a target.

FIG. 7(b) shows an actual measurement effect of localized vibrotactile feedback obtained by a laser vibration measurement process.

FIGS. 7(c) and 7(d) show vibration displacement distributions along the x-direction and y-direction, respectively.

FIGS. 8(a)-(d) further illustrate speed information of vibration fields at target vibration positions in FIGS. 7(a)-7(d).

FIG. 9(a) shows a designed two-point localized vibrotactile feedback effect as a target.

FIGS. 9(b)-9(c) show actual measurement effects of two-point localized vibrotactile feedback obtained by a laser vibration measurement process.

FIGS. 10(a)-10(f) show 5-point localized vibrotactile feedback effects obtained by a laser vibration measurement process, where only about 10 eigenmodes are used.

FIG. 11 shows a structural block diagram of an apparatus for generating localized vibrotactile feedback at a target vibration position of a vibration plate according to an embodiment of the present application.

### DETAILED DESCRIPTION

The technical solutions in the embodiments of the present application will be clearly and thoroughly described below with reference to the drawings in the embodiments of the present application. Obviously, the described embodiments are only some of, but not all of the embodiments of the present application. Based on the embodiments of the present application, all other embodiments obtained by those of ordinary skill in the art without creative efforts fall within the scope of protection of the present application.

The present disclosure is mainly used to generate localized vibrotactile feedback at one or more target vibration positions of a vibration plate. In order to better describe the present disclosure, a brief introduction is first made to the principle of vibration generation at various positions of the vibration plate.

For a uniform, isotropic, homogeneous thin plate (i.e. a vibration plate), deformation occurs primarily perpendicular to the plane direction, which may be used to achieve tactile feedback. According to Kirchhoff plate theory, a dynamic equation of a rectangular flat plate in free vibration may be expressed as:

$$( D {∇}^{4} - ρ {h}_{t} \frac{{\partial }^{2}}{\partial {t}^{2}} ) w ( x , y , t ) = 0 , \qquad Formula ( 1 )$$

where

$$D = \frac{E {h}_{t}^{3}}{12 ( 1 - {ν}^{2} )}$$

is bending stiffness, ρ is a density of the plate, hₜ is thickness, E is elastic modulus, vis Poisson's ratio. ∇⁴=∇²∇², ∇² is a Laplacian operator, w(x,y,t) represents a vibration field corresponding to position (x,y) and time t at which the vibration occurs. A solution to Formula (1) may be written in a variable-separated form as:

w(x,y,t)=φ(x,y)sin(ωt+φ), Formula (2)

where φ(x,y) is a bending mode of the rectangular flat plate at position (x,y), φ is an initial phase, ω is an angular frequency. Then a mode shape equation of the bending mode may be expressed as:

D∇⁴φ(x,y)−ρhₜω²φ(x,y)=0, Formula (3)

Solutions of Formula (3) are eigenmode shapes of a series of eigenmodes of the rectangular plate (also called mode shapes) φₙ(x,y), n is the n-th mode, depending on boundary conditions. Each mode has a specific natural frequency, damping ratio, and mode shape. Typically, a natural angular frequency of the n-th mode on may be expressed as:

$${ω}_{n} = \frac{{λ}_{i j}^{2}}{{a}^{2}} \sqrt{\frac{D}{ρ {h}_{t}}} , \qquad Formula ( 4 )$$

Correspondingly, a resonant frequency, fₙ, may also be derived from the natural angular frequency, and λᵢⱼ is dependent only on the order of the n-th eigenmode, the length-width ratio, a/b, of the vibration plate, and the boundary conditions. If the mode shape is normalized according to the vibration mass, the mode shape satisfies the orthogonality:

∫∫_{S}ρhₜφ̅ₖ̅(x,y)φ̅ₗ̅(x,y)dxdy=δₖₗ, Formula (5)

where δₖₗ is a Kronecker symbol, φ̅ₖ̅ represents the normalized mode k. Because of orthogonality and an infinite number of bending modes, mode shapes φ̅ₖ̅(x,y) construct a complete set of bases. That is, any periodic vibration may be expressed in terms of modal decomposition as:

$$w ( x , y , t ) = {\sum }_{n = 1}^{∞} {η}_{n} {φ}_{n} ( x , y ) sin ( {ω}_{n} t + {ϕ}_{n} ) , \qquad Formula ( 6 )$$

There are an infinite number of modes, ηₙ is a modal participation coefficient of the n-th eigenmode (weight, i.e., how much this mode contributes to a localized vibrotactile feedback effect to be generated), φₙ is the n-th eigenmode shape, φₙ is an initial phase of the n-th eigenmode. From the orthogonality and completeness of the eigenmode shapes, any artificially designed localized vibration effect, i.e. an expected vibration field at position (x,y) that varies with time t, may be constructed. Superposed vibration fields of an infinite number of modes may also be expressed in complex form as:

$$w ( x , y , t ) = R e ( {\sum }_{n = 1}^{∞} {a}_{n} {φ}_{n} ( x , y ) {e}^{i {ω}_{n} t} ) , \qquad Formula ( 7 )$$

where aₙ=ηₙe^{iφ}^{ₙ} is modal participation coefficient in complex form, which facilitates the relevant solution in the following steps. However, in practical applications, the number of available modes is limited because higher-order modes are difficult to measure and excite experimentally (i.e., higher-order modes cannot be easily acquired). Therefore, assuming that the first N modes are available, superposed vibration fields of N modes w(x,y,t) may be expressed in terms of a truncated mode as follows:

$$w ( x , y , t ) = R e ( {\sum }_{n = 1}^{N} {a}_{n} {φ}_{n} ( x , y ) {e}^{i {ω}_{n} t} ) , \qquad Formula ( 8 )$$

With the above introduction, it can be seen that localized vibrotactile feedback may be achieved based on modal superposition.

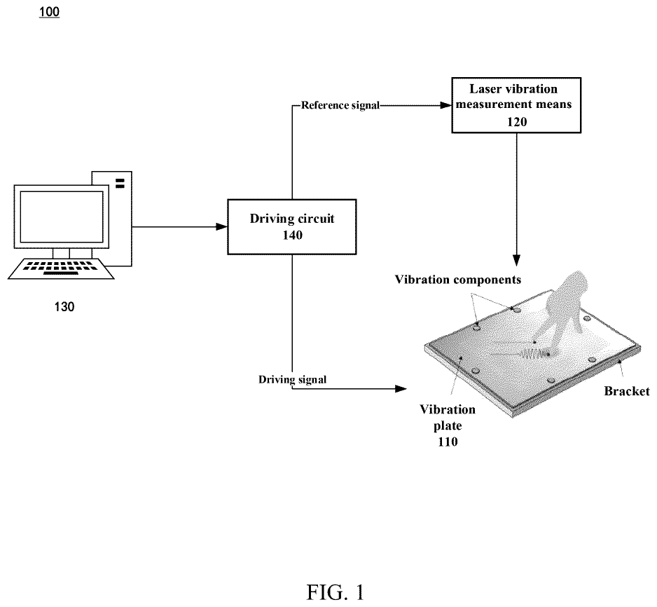

FIG. 1 shows a schematic diagram of a system for generating localized vibrotactile feedback at a target vibration position of a vibration plate according to an embodiment of the present application. Optionally, the number of target vibration positions may be one or more.

The system 100 may include a vibration plate 110, laser vibration measurement means 120, processing means 130, and a driving circuit 140.

The vibration plate 110 may be provided with a plurality of vibration components (e.g., a plurality of piezoelectric patches provided on peripheral edges of the vibration plate), which are respectively vibrated by corresponding driving signals, thereby generating localized vibrotactile feedback at the target vibration position on the vibration plate. The vibration plate 110 may be various carriers that integrate tactile feedback, such as glass plates, display screens, touch pads, smart surfaces, and the like, which can enhance human-computer interaction experience, as shown in FIG. 1.

The laser vibration measurement means 120 (e.g., comprising a laser Doppler vibrometer and its corresponding vibrometer controller) is used to measure a set of eigenmodes of the vibration plate and various vibrations on the vibration plate. For example, the vibrometer controller may obtain a vibration measurement reference signal for use in a laser vibration measurement process. For a uniform, isotropic, homogeneous thin plate, deformation occurs mainly perpendicular to the plane direction, which may be used to achieve tactile feedback. Furthermore, for a vibration plate of any material and properties, there is a corresponding plurality of eigenmodes that are inherently present and related to an inherent hardware configuration of the vibration plate, and once one or more of the eigenmodes are excited, haptic feedback may be achieved on the vibration plate 110 by superposition of the excited eigenmodes. Thus, after determining the material, dimensions, and other various hardware parameters of the vibration plate, the laser vibration measurement means 120 may be used to measure the set of eigenmodes of the vibration plate (e.g., based on frequency responses and using a peak determination method (i.e., one eigenmode at each peak). After the set of eigenmodes has been identified, it may be stored as a complex matrix (including information such as amplitudes, phases, and the like of respective modes), for example locally or in a storage device separate from the laser vibration measurement means.

The processing means 130 is used to obtain the set of eigenmodes measured by the laser vibration measurement means, and generate, based on the target vibration position where localized vibrotactile feedback is expected to occur and its reference vibration field (during actual processing, the reference vibration field of the target vibration position may be set to 1 for convenience of calculation, i.e., the amplitude at a certain time (e.g., t=0) at the target vibration position is set to 1), driving control information for controlling the driving circuit to generate driving signals for driving the plurality of vibration components, thereby generating localized vibrotactile feedback at the target vibration position. The process of how the processing means generates driving control information will be described in detail later. The processing means 130 may be any device with processing functions, and may be implemented in a combination of hardware and software. For example, the processing means may include a memory and a processor, so that the processor may execute a computer program stored on the memory.

The driving circuit 140 is configured to generate and output driving signals to drive the plurality of vibration components based on the driving control information from the processing means, so that the plurality of vibration components drive the vibration plate to vibrate.

Optionally, the driving circuit may include a waveform generation circuit and a voltage amplification circuit. The waveform generation circuit generates, based on the driving control information, a multi-channel voltage signal for a plurality of channels (corresponding to the plurality of vibration components) having a waveform indicated by the driving control information. The waveform generation circuit may be multi-channel, and the voltage amplification circuit may also be multi-channel, that is, each channel may include a waveform generation circuit and a voltage amplification circuit, so that the voltage amplification circuit of each channel may be used to perform voltage amplification on the voltage signal generated by the waveform generation circuit of the corresponding channel, to generate driving signals for driving the plurality of vibration components, respectively.

Each channel may realize output of a voltage signal with any excitation waveform, and the number of channels may be the same as the number of vibration components, thereby realizing one-to-one driving of the vibration components. In this way, the driving control information (voltage information) calculated by the processing means 130, including the driving control information for driving the vibration components, is converted into actual voltage signals by the driving circuit to drive (excite) the corresponding vibration components (e.g., piezoelectric patches) to generate vibration. Optionally, the waveform generation circuit also provides a reference signal for laser vibration measurement when scanning a vibration field.

It should be understood that FIG. 1 only illustrates several components within the system 100 and does not constitute a limitation on components included in the system. In practice, the system may also include many more components. For example, the system 100 may also include a power module (e.g., a battery or a voltage converter, etc.), to supply power to, for example, the processing means, the driving circuit, and the like within the system.

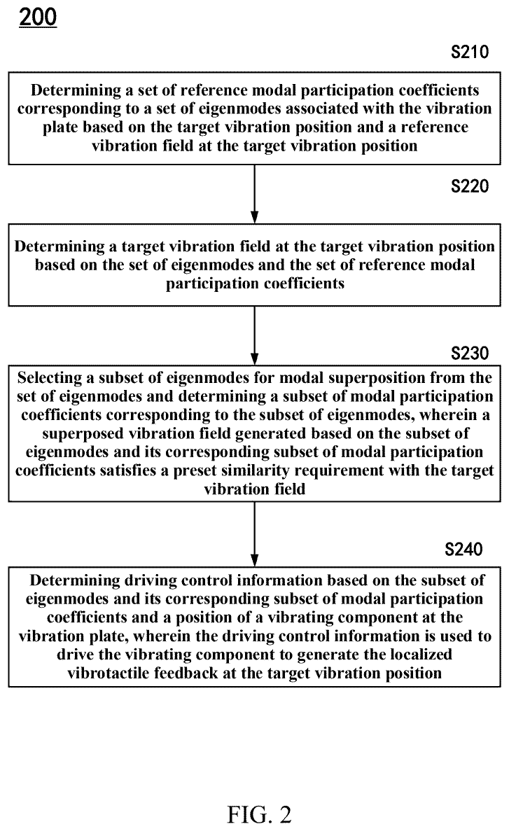

FIG. 2 shows a schematic flowchart of a method for generating localized vibrotactile feedback at a target vibration position of a vibration plate according to an embodiment of the present application. The method shown in FIG. 2 may be performed by the controller in FIG. 1.

As shown in FIG. 2, in step S210, a set of reference modal participation coefficients corresponding to a set of eigenmodes associated with the vibration plate are determined based on a target vibration position and a reference vibration field at the target vibration position.

Optionally, the number of target vibration positions may be one or more, that is, it is expected that corresponding localized vibrotactile feedback may be achieved at these target vibration positions (represented by multiple sets of coordinates (x,y)) by superposition of these eigenmodes. The reference vibration field may be used to represent localized vibrotactile feedback desired to be achieved at the target vibration position, and in the case of multiple target vibration positions, there are corresponding multiple reference vibration fields.

For example, a spatial grid of positions on the vibration plate may be divided into multiple localized vibration regions arranged in S rows and T columns, and one or more discrete positions may be located within each localized vibration region. Generally, in order to increase the resolution as much as possible (reduce areas of the localized vibration regions so that the total number of discrete positions is larger), the area of each localized vibration region may be reduced and only one position element is set to 1 in that region. That is, only one discrete position is set in each localized vibration region of the vibration plate, that is, it is represented by only one corresponding coordinate (x,y). A reference vibration field matrix may be used to represent reference vibration fields at the preset number of discrete positions. For example, values of 0 and 1 at each position of the reference vibration field matrix arranged in S rows and T columns, corresponding to the region matrix arranged in S rows and T columns, may indicate whether vibration is expected to occur at the corresponding discrete position on the vibration plate. An element in the reference vibration field matrix corresponding to the target vibration position will be set to a value of 1, and elements corresponding to the remaining positions will be set to values of 0. Of course, the reference vibration field may also be set in other ways. For example, an element in the reference vibration field matrix corresponding to one target vibration position may be set to 1, and an element corresponding to another target vibration position may be set to 2, so that the relationship of amplitudes of vibration at the two target vibration positions at the same time may be approximately doubled.

Optionally, in determining the reference modal participation coefficients from the reference vibration field, for each discrete position of the preset number of discrete positions on the vibration plate, a vibration field representation at the discrete position may be determined based on a measured mode shape of each eigenmode at the discrete position and an unknown modal participation coefficient corresponding to each eigenmode; and a value of the modal participation coefficient corresponding to each eigenmode may be adjusted and the value of the modal participation coefficient corresponding to each eigenmode that minimums a sum of differences between the vibration field representation at each discrete position and the corresponding reference vibration field may be taken as the reference modal participation coefficient corresponding to each eigenmode in the set of eigenmodes.

For example, it may be assumed that the reference vibration field w^{r}(x,y) at the target vibration position (x,y) is obtained at t=0, although the reference vibration field may also be obtained at other suitable times or frequencies depending on how the vibration field is represented. Furthermore, unlike theoretically vibrations at various discrete positions on the vibration plate either in the same direction (phase 0°) or opposite direction (phase) 180°, in practice, phase fields of vibrations at various discrete positions are not binary, but are within the range of [−10°, 10°] or [170°, 190°], and thus need to be described with a complex matrix.

Therefore, the reference vibration field may be expressed in complex form as follows in conjunction with the above Formula (8).

$$R e ( {w}^{r} ( x , y ) ) = w ( x , y , 0 ) = R e ( {\sum }_{n = 1}^{N} {a}_{n} {φ}_{n} ( x , y ) ) , \qquad Formula ( 9 )$$

Additionally, the coordinate (x,y) of the target vibration position may be rewritten in discrete form based on the position space grid (S rows and T columns) when the eigenmodes are measured. Therefore, Formula (9) may be expressed as:

$$[ \begin{matrix}{w}_{1}^{r} \\ {w}_{2}^{r} \\ ⋮ \\ {w}_{M}^{r}\end{matrix} ] = [ \begin{matrix}{φ}_{11} & {φ}_{12} & … & {φ}_{1 N} \\ {φ}_{21} & {φ}_{22} & … & {φ}_{2 N} \\ ⋮ & ⋮ & ⋱ & ⋮ \\ {φ}_{M 1} & {φ}_{M 2} & … & {φ}_{MN}\end{matrix} ] [ \begin{matrix}{a}_{1}^{r} \\ {a}_{2}^{r} \\ ⋮ \\ {a}_{N}^{r}\end{matrix} ] , \qquad Formula ( 10 )$$

where M is the number of discrete positions, N is the number of eigenmodes in the set of measured eigenmodes, wₘ^{r}=w^{r}(xₘ,yₘ) (where m=1, 2, . . . , M) is the reference vibration field at the m-th discrete position. If it is not desired to generate localized vibrotactile feedback at a discrete position, the corresponding reference vibration field is 0, and is 1 otherwise. φₘₙ=φₙ(xₘ,yₘ) (m=1, 2, . . . , M) is the mode shape of the n-th eigenmode at the m-th discrete position. aₙ^{r} is the modal participation coefficient corresponding to the n-th eigenmode. For example, the vibration field representation at discrete position 1 may be φ₁₁*a₁^{r}+φ₁₂*a₂^{r}+ . . . +φ_{1N}*a_{N}^{r}, and the vibration field representation at discrete position 2 may be φ₂₁*a₁^{r}+φ₂₂*a₂^{r}+ . . . +φ_{2N}*a_{N}^{r}, and so on.

Formula (10) is a linear system of equations. In general, the number of discrete positions M is much larger than the number of eigenmodes N that can be measured, so Formula (10) is an overdetermined system of equations, in which case aₙ^{r} cannot strictly satisfy the system of Formula (10). In order to obtain the weighted participation coefficient for each eigenmode for superimposing localized vibrotactile feedback at the target vibration position, the problem becomes finding the best fit aₙ^{r}. That is, a superposed vibration field actually obtained by superposing these eigenmodes cannot exactly coincide with an artificially set reference vibration field, but the modal participation coefficient corresponding to each eigenmode can be determined such that a difference between the superposed vibration field and the reference vibration field is as small as possible.

For example, where the preset number M of the discrete positions is greater than the first number N of eigenmodes in the set of eigenmodes, an overdetermined system of equations is constructed based on the vibration field representation at each discrete position (m), and the corresponding reference vibration field, with the first number of unknown modal participation coefficients in the vibration field representation at each discrete position as equation variables. The system of overdetermined equations is then solved using a least square solution to obtain a value of the reference modal participation coefficient corresponding to each eigenmode for which a sum of differences between the vibration field representation at each discrete position and the corresponding reference vibration field is the minimum.

For example, it may be determined in the following manner.

Matrix Formula (10) may be abbreviated as:

W^{r}=ΦA, Formula (11)

where Φ is an M×N matrix, and M>N. Formula (11) is solved using the pseudo-inverse method. Matrix Φ may be expressed by singular value decomposition as:

Φ=UΣV^{T}, Formula (12)

where U is an M x M orthogonal matrix, Vis an N×N orthogonal matrix, and Σ is an M×N diagonal matrix. Then Σ^{†} is an N×M diagonal matrix, satisfying:

ΣΣ^{†}=I_{M×M}, Formula (13a)

Σ^{†}Σ=I_{N×N}. Formula (13b)

Then pseudo-inverse Φ^{†} of the matrix Φ may be expressed as:

Φ^{†}=VΣ^{†}U^{T}. Formula (14)

The modal participation coefficient may be expressed as:

A=Φ^{†}W^{t}, Formula (15)

Therefore, the overdetermined equation may be solved by a least square method to obtain the optimal solution of A:

$${min}_{A} ‖ {W}^{r} - Φ A ‖ . \qquad Formula ( 16 )$$

In step S220, a target vibration field at the target vibration position is determined based on the set of eigenmodes and the set of reference modal participation coefficients.

Theoretically, the modal participation coefficient corresponding to each eigenmode is determined from the reference vibration field, as shown in Formula (16). However, due to the truncation of the eigenmodes (i.e., truncation of higher-order eigenmodes that are not available by measurement), the actual resulting superposed vibration field at each target vibration position may not be exactly the same as the artificially set reference vibration field.

For example, the target vibration field at the target vibration position may be obtained by superposing all N eigenmodes and the corresponding reference modal participation coefficients obtained in step S210, and then combining the position coordinate of the target vibration position. This target vibration field will be used for subsequent comparison with a superposed vibration field based on superposition of a smaller number of eigenmodes. The vibration field based on the superposition of all the eigenmodes (N) is referred to as the target vibration field because it is desirable to use as few eigenmodes as possible but to be similar to the vibration field based on the superposition of all the eigenmodes (N). The target vibration field at the target vibration position (x,y) w^{t} may be expressed as follows:

$${w}^{t} ( x , y , t ) = {\sum }_{n = 1}^{N} {a}_{n} {φ}_{n} ( x , y , t ) {e}^{i 2 π {f}_{n} t} , \qquad Formula ( 17 )$$

In step S230, a subset of eigenmodes for modal superposition is selected from the set of eigenmodes and a subset of modal participation coefficients corresponding to the subset of eigenmodes is determined, wherein a superposed vibration field generated based on the subset of eigenmodes and its corresponding subset of modal participation coefficients satisfies a preset similarity requirement with the target vibration field.

In some cases, the second number N2 of eigenmodes in the selected subset of eigenmodes is equal to the first number N of eigenmodes in the set of eigenmodes, i.e. all eigenmodes in the set of eigenmodes (N eigenmodes as described above) are used for modal superposition. In this case, a modal participation coefficient corresponding to each eigenmode in the subset of eigenmodes is the same as the reference modal participation coefficient, and the generated superposed vibration field (the target vibration field) must be sufficiently similar to the reference vibration field since all eigenmodes are superposed, which is already the best superposition result that can be achieved, Therefore, it may be used as the goal to be achieved in subsequent parts herein (as a party to similarity comparison in the iterative process).

In other cases, considering that the more eigenmodes selected, the greater the number of vibration components on the vibration plate, and the corresponding circuit complexity (such as the number of channels) and the algorithm computational load will increase, only some of the eigenmodes may be selected from the set of eigenmodes to be superposed, as long as a required localized vibrotactile feedback can be achieved at the target vibration position. Furthermore, since original modal participation coefficients are determined for all of the eigenmodes based on the reference vibration field, when the fewer eigenmodes to be actually used are determined, corresponding modal participation coefficients need to be re-determined for the fewer eigenmodes based on the reference vibration field (e.g., Formula 16), in which case the re-determined modal participation coefficients are different from the reference modal participation coefficients corresponding to the eigenmodes. The generated superposed vibration field and the target vibration field need to meet the similarity requirement in order to produce the desired localized vibrotactile feedback at the target vibration position.

It should be noted that, theoretically, the superposed vibration field should be compared with the reference vibration field, but since the reference vibration field is a value at time t=0 as mentioned above, and the superposed vibration field is a time-varying signal, it is theoretically feasible even if to compare its value at t=0 with the reference vibration field (e.g. 1) to determine similarity. However, in order to better compare the dynamics or localized vibration patterns, the superposed vibration field may be compared with the target vibration field to determine whether the selected subset of eigenmodes can already be used to generate localized vibrotactile feedback at the target vibration position.

Further, in order to compare the superposed vibration field with the target vibration field, the embodiments of the present application propose an algorithm that may be based on a structural similarity index (SSIM). The structural similarity is a similarity between two superposed vibration fields superposed for two sets of different numbers of eigenmodes, and thus the similarity between the superposed vibration field and the reference vibration field may be approximately reflected based on the structural similarity between the superposed vibration field and the corresponding target vibration field (which is sufficiently similar to the reference vibration field).

The present application uses SSIM to evaluate the similarity between two localized vibration modes (i.e., two vibration fields). Assuming that w¹ (x,y) and w² (x,y) are vibration fields superposed by two different numbers of modes, the calculation formula of SSIM is:

$$SSIM ( {w}^{1} , {w}^{2} ) = \frac{( 2 {μ}_{1} {μ}_{2} + {C}_{1} ) ( 2 {σ}_{12} + {C}_{2} )}{( {μ}_{1}^{2} + {μ}_{2}^{2} + {C}_{1} ) ( {σ}_{1}^{2} + {σ}_{2}^{2} + {C}_{2} )} , \qquad Formula ( 18 )$$

where μ₁ and μ₂ are average values of vibration displacement distributions of vibration fields w¹ and w², σ₁ and σ₂ are standard deviations of vibration displacements in w¹ and w², σ₁₂ is a covariance of w¹ and w², C₁ and C₂ are two constants. These indexes mainly consider three key characteristics of mode shapes and are expressed as: average vibration displacements, standard deviation of vibration displacements (contrast), and similarity of vibration field structures (structures), respectively. SSIM adopts

$$\frac{2 {μ}_{1} {μ}_{2} + {C}_{1}}{{μ}_{1}^{2} + {μ}_{2}^{2} + {C}_{1}} , \frac{2 {σ}_{1} {σ}_{2} + {C}_{2}}{{σ}_{1}^{2} + {σ}_{2}^{2} + {C}_{2}} and \frac{2 {σ}_{12} + {C}_{2}}{2 {σ}_{1} {σ}_{2} + {C}_{2}}$$

to measure the above three key characteristics, respectively, and the results are multiplied. SSIM enables quantitative assessment of similarities between localized vibration modes, thereby preserving localized vibration regions of the target.

The method for selecting the subset of eigenmodes for superposition based on similarity will be described in detail later.

In step S240, driving control information is determined based on the subset of eigenmodes and its corresponding subset of modal participation coefficients and a position of a vibration component at the vibration plate, wherein the driving control information is used to drive the vibration component to generate the localized vibrotactile feedback at the target vibration position.

As described with reference to the system of FIG. 1, the vibration component vibrates based on a driving signal (or its signal after high voltage amplification), thereby causing the vibration plate to vibrate. A combination of various driving signals applied to various vibration components is different for the different selected subsets of eigenmodes. For example, various driving signals required to be applied to various vibration components when the selected eigenmodes are Mode 1 and Mode 2 are different from various driving signals required to be applied to various vibration components when the selected eigenmodes are Mode 1, Mode 2, and Mode 3.

It is therefore necessary to determine a driving signal that needs to be applied to each vibration component i based on the selected subset of eigenmodes (assumed to be a number P of eigenmodes) and the corresponding modal participation coefficients, for example:

$${U}^{i} = {U}^{am} R e ( {\sum }_{n = 1}^{P} {a}_{n}^{r} {e}^{i ( 2 π {f}_{n} t + {φ}_{n} ( {x}_{i} , {y}_{i} ) )} ) , \qquad Formula ( 19 )$$

where Uⁱ is an excitation voltage of the driving signal of the i-th vibration component, and U^{am} is a voltage amplitude that can be provided to each vibration component (for example, provided by the power module in FIG. 1). (xᵢ,yᵢ) is the position of the i-th vibration component, from which a phase condition of each mode shape φₙ(xᵢ,yᵢ) at the position of the i-th vibration component can be obtained. aₙ^{r} is the modal participation coefficient for each of the P eigenmodes (calculated based on the target vibration position and its reference vibration field as well as the selected P eigenmodes).

After the driving signal to be applied to each vibration component i has been determined, information about these driving signals (i.e., driving control information) may be provided to a driving circuit capable of generating driving signals (e.g., the driving circuit shown in FIG. 1), so that the driving circuit may generate and output the driving signals based on the driving control information.

Driven or excited by the corresponding voltage driving signal, the vibration component may achieve localized vibrotactile feedback at the target vibration position.

By the method for generating localized vibrotactile feedback at a target vibration position of a vibration plate described with reference to FIG. 2, localized vibrotactile feedback that is sufficiently similar to a required localized vibrotactile feedback effect may be achieved by superposition of multiple modes, and the number of selected modes may be smaller than the number of modes in the eigenmode set, thereby reducing the corresponding circuit complexity (such as the number of channels) and the algorithm computational load.

Optionally, when a larger number of eigenmodes are used for superposition, a resonance frequency fₙ associated with each eigenmode may be obtained from the natural angular frequency ωₙ shown by Formula (4), and from Formula (4), it can be seen that the resonant frequency of each eigenmode fₙ is deterministic because it depends on boundary conditions, the plate width-to-length ratio, and the order number. The superposed vibration field generated by superposing multiple eigenmodes may include high-frequency vibration components and low-frequency vibration components, and some of the high-frequency vibration components may not be within the frequency range that can be perceived by the human body (e.g., 50 Hz to 500 Hz).

An envelope of the superimposed vibration field (as shown in Formula (17)) w^{t} is expressed as:

$${{w}^{e} ( x , y , t )}^{2} = {\vert {w}^{t} ( x , y , t ) \vert}^{2} = ( {\sum }_{m = 1}^{N} {a}_{m} {φ}_{m} ( x , y ) {e}^{i 2 π {f}_{m} t} ) \cdot ( {\sum }_{n = 1}^{N} \overline{{a}_{n}} \overline{{φ}_{n} ( x , γ )} {e}^{- i 2 π {f}_{n} t} ) = {\sum }_{k = 1}^{N} {\vert {a}_{k} \vert}^{2} {φ}_{k}^{2} ( x , y ) + {\sum }_{m = 1}^{N} {\sum }_{n = 1}^{m - 1} ( {a}_{m} \overline{{a}_{n}} + \overline{{a}_{m}} {a}_{n} ) {φ}_{m} ( x , y ) \overline{{φ}_{n} ( x , y )} cos 2 π ( {f}_{m} - {f}_{n} ) t \qquad Fomrula ( 20 )$$

The first term of Formula (20) is constant in time. The second term results in a change in an envelope wave of a difference between two resonant frequencies. In order to produce strong vibrotactile feedback, it can be seen from Formula (4) that the resonant frequency depends on the boundary conditions of the vibration plate, the plate width-to-length ratio, and the order number. Therefore, the above-mentioned hardware parameters may be optimized when selecting a hardware configuration of the vibration plate so that the resonance frequency difference satisfies the formula of:

fₘᵢₙ<fᵢ₊₁−fᵢ<fₘₐₓ Formula (21)

where fᵢ is the resonance frequency of the i-th eigenmode, fₘᵢₙ and fₘₐₓ are set to 50 Hz and 300 Hz, respectively.

In this way, possible high-frequency vibration components in the superposed vibration field may be modulated into low-frequency envelope waves, so that they can be better perceived, and since wavelengths of the high-frequency vibration components are shorter, this characteristic can be maintained, thus achieving tactile feedback effects with also a higher resolution (smaller area). That is, even if all eigenmodes are superposed, the superposed vibration field achieves an improvement since it is better perceived relative to existing solutions.

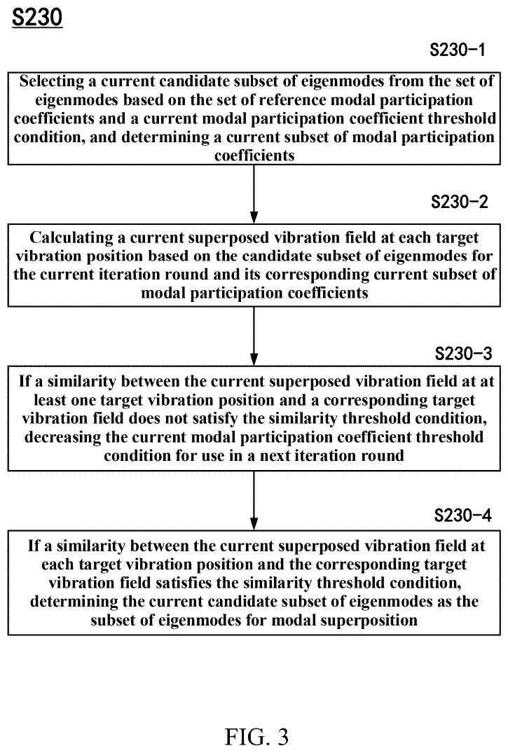

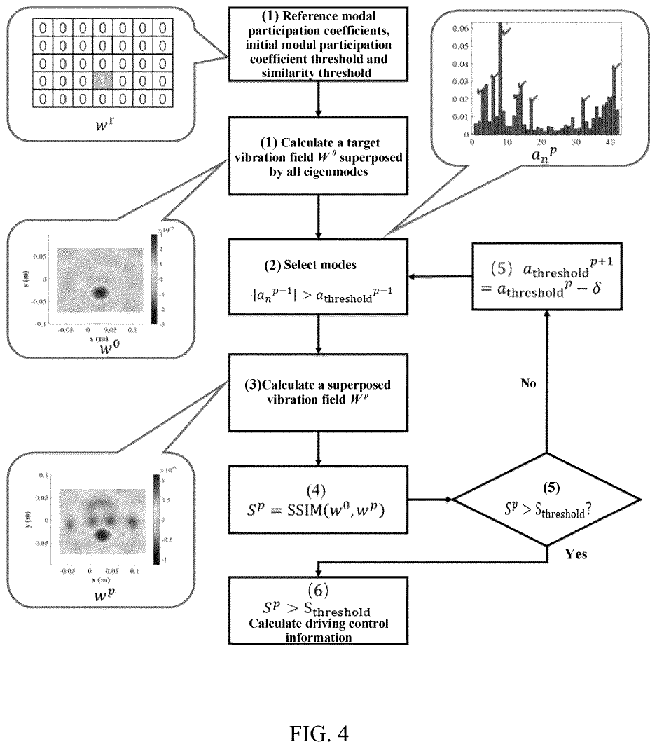

The process of selecting the subset of eigenmodes in step S230 of FIG. 2 will be described in detail below with reference to FIGS. 3-4.

As mentioned above, in some cases, all the measured eigenmodes may be used for superposition, and accordingly based on envelope wave modulation, so that the superposed vibration field at the target vibration position and the reference vibration field can be maximally similar, and a better tactile feedback effect can also be achieved.

Additionally, in other cases, the number of selected eigenmodes may be less than the total number of eigenmodes in the set of eigenmodes, thereby reducing the corresponding circuit complexity (e.g., the number of channels) and the algorithm computational load, as will be described below for how to select the eigenmodes in such cases.

As mentioned before, the calculation of all eigenmodes and the respective reference modal participation coefficients on which the target vibration field is based is the optimal solution that can be obtained, so that the target vibration field may be targeted for a superposed vibration field based on superposition of fewer eigenmodes. In addition, the number of target vibration positions may also be one or more. Thus, candidate eigenmodes for modal superposition may be selected from the set of eigenmodes in increasing numbers in different iteration rounds as candidate subsets of eigenmodes, until one or more superposed vibration fields at one or more target vibration positions determined based on a selected candidate subset of eigenmodes in the latest iteration round and its corresponding subset of modal participation coefficients satisfy a similarity threshold condition with corresponding target vibration fields. In the present application, the similarity threshold condition may correspond to a threshold, and satisfying the condition may be greater than the threshold or less than the threshold according to different condition setting methods. Similarly, the modal participation coefficient threshold condition below may also be interpreted in this way, which is not limited in the present application. Whether the preset similarity requirement is met depends on whether the corresponding superposed vibration field and the target vibration field satisfy the similarity threshold condition.

For example, in the case where there is only one target vibration position, the situation is simple, that is, there is only comparison and iteration for the superposed vibration field and the target vibration field at the one target vibration position. In the case where there are multiple target vibration positions, and corresponding multiple reference vibration fields with non-zero values, as previously described, the determination of the set of reference modal participation coefficients is also based on the reference vibration field for each discrete position (including these target vibration positions) (as shown in Formulas (10) and (15)). Then, the target vibration field at each target vibration position may be determined from the set of eigenmodes and the set of reference modal participation coefficients as well as each target vibration position. Furthermore, it may be determined whether the superposed vibration field superposed at each target vibration position based on the currently selected candidate subset of eigenmodes and their corresponding modal participation coefficients satisfies the similarity threshold condition with its corresponding target vibration field, and the iteration is stopped only when the superposed vibration field superposed at each target vibration position and its corresponding target vibration field satisfies the similarity threshold condition.

As mentioned earlier, a similarity between two vibration fields (corresponding to different subsets of eigenmodes) may be determined based on a structural similarity index, so herein the similarity threshold condition may correspond to a structural similarity threshold.

For example, the set of reference modal participation coefficients aₙ⁰ (N is an integer between 1 and the number N of all eigenmodes) corresponding to all eigenmodes calculated based on one or more reference vibration fields w^{r} (corresponding to one or more target vibration positions, respectively) constitute a sequence, which may be numbered, for example, as φ₁, φ₂, . . . φ_{N}.

Then, set an initial threshold a_{threshold}⁰ for subsequent selection of eigenmodes, that is, starting from the first iteration procedure, eigenmodes with modal participation coefficients larger than this initial threshold may be used for superposition and the threshold may be updated depending on the effect of the superposed vibration field generated by the selected eigenmodes for use in a next iteration if required. In addition, a similarity threshold S_{threshold} may also be set, that is, if the similarity between the superposed vibration field obtained based on the current eigenmodes and the target vibration field is greater than or equal to the similarity threshold (or the superposed vibration field or the corresponding reference vibration field at each target vibration position is greater than or equal to the similarity threshold), the iteration may be stopped.

The target vibration field at position (x,y) (i.e., the target vibration field) is expressed as previously described as follows:

$${w}^{0} ( x , y , t ) = {\sum }_{n = 1}^{N} {a}_{n}^{0} {φ}_{n} ( x , y ) {e}^{i 2 π {f}_{n} t} , \qquad Formula ( 22 )$$

Optionally, in general, the initial threshold a_{threshold}⁰ will be set to [0.3, 0.5]*max{aₙ⁰}, and the similarity threshold S_{threshold}, a threshold set according to tolerance of a localized vibration pattern corresponding to the generated superposed vibration field (which may also be obtained by laser vibration measurement means), is generally set to 0.2 to 0.6, and may be adjusted based on tolerance of vibration amplitudes outside the desired target vibration position region (region of localized vibration position). Generally within this numerical range, it may be observed that vibrations outside the target localized vibration region are suppressed to be smaller relative to vibrations within this region. Generally, when the complexity of the vibration field is high, the similarity threshold may be appropriately relaxed.

The process of selecting a candidate subset of eigenmodes in each iteration round may include the following operations.

For example, as shown in FIG. 3, in operation S230-1, a candidate subset of eigenmodes for a current iteration round may be selected from the set of eigenmodes based on the set of reference modal participation coefficients and a current modal participation coefficient threshold condition, and a current subset of modal participation coefficients corresponding to the candidate subset of eigenmodes for the current iteration round may be determined.

Therefore, in the first iteration round, the initial threshold a_{threshold}⁰ is usually set to be large, so that only a small number of modal participation coefficients greater than the initial threshold can be selected from all reference modal participation coefficients aₙ⁰, that is, only a smaller number of eigenmodes can be selected as the candidate subset of eigenmodes for the current first iteration round. In this case, since the selected candidate subset of eigenmodes needs to be superposed to achieve the reference vibration field (or target vibration field) at the one or more target vibration positions to the greatest possible extent, modal participation coefficients corresponding to the candidate subset of eigenmodes need to be re-determined according to the reference vibration field at the one or more target vibration positions (e.g. the reference vibration field matrix) as the current subset of modal participation coefficients. In addition, in the case where it is determined that iteration is required based on subsequent operations, for other iteration rounds, the threshold value for modal participation coefficients may be updated, for example, decreased, so that more modal participation coefficients greater than the initial threshold than in the first iteration round may be selected from the reference modal participation coefficients aₙ⁰, thereby selecting more eigenmodes, and recalculating the corresponding modal participation coefficients.

That is, for the p-th iteration round, based on the current a_{threshold}^{p-1} (may be the initial threshold or a previously updated threshold.), participation coefficients larger than the current a_{threshold}^{p-1} may be selected from the set of reference modal participation coefficients aₙ⁰, so that:

$$\vert {a}_{n}^{p - 1} \vert > {a}_{threshold}^{p - 1} for \qquad Formula ( 23 )$$

$$n ∈ \{ {i}_{1}^{p} , … , {i}_{{N}^{p}}^{p} \} , and$$

$${i}_{{N}^{p}}^{p} ∈ \{ 1 , 2 , … N \}$$

where

$${i}_{T}^{p}$$

is the order number of eigenmodes selected from the set of eigenmodes in the p-th iteration round (the candidate subset of eigenmodes for the current iteration round) for computation in the p-th iteration round, τ=1, 2, . . . , N^{p} is the order number in the candidate subset of eigenmodes selected in the p-th iteration round. For example, the candidate subset of eigenmodes for the current iteration round may include 5 modes (Mode 1, Mode 3, Mode 5, Mode 12, Mode 15), then τ=1, 2, . . . , 5.

In operation S230-2, a current superposed vibration field at each of the one or more target vibration positions is calculated based on the candidate subset of eigenmodes for the current iteration round and its corresponding current subset of modal participation coefficients.

For example, in the p-th iteration round, for the target vibration position (x,y), the superposed vibration field generated for the candidate subset of eigenmodes for the current iteration round and the corresponding current subset of modal participation coefficients is expressed as:

$${w}^{p} ( x , y , t ) = {\sum }_{n ∈ \{ {i}_{1}^{p} , … , {i}_{{N}^{p}}^{p} \}} {a}_{n}^{p} {φ}_{n} ( x , y ) {e}^{i 2 π {f}_{n} t} , \qquad Formula ( 24 )$$

In operation S230-3, if a similarity between the current superposed vibration field at at least one target vibration position and the corresponding target vibration field does not satisfy the similarity threshold condition, the current modal participation coefficient threshold condition is decreased for use in a next iteration round.

For example, for each target vibration position, based on the structural similarity index SSIM between the target vibration field obtained based on the superposition of all eigenmodes and the superposed vibration field obtained based on the selected partial eigenmodes in Formula (24), it is determined whether Sₚ>S_{threshold} is true.

S^{p}=SSIM(w⁰,w^{p}), Formula (25)

If it does not hold true for at least one target vibration position, the current modal participation coefficient threshold is updated, for example, decreased, according to the calculation process in the p-th iteration round, to obtain a_{threshold}^{p} as the threshold for the next iteration round (i.e., the (p+1)-th iteration):

a_{threshold}^{p}=a_{threshold}^{p-1}−δ, Formula (26)

where δ is an iteration step size of the participation parameter threshold, typically set to [0.01, 0.05]*max{aₙ⁰}. It should be pointed out that a too large step size will cause the final result to deviate from the optimal critical structure, while a too small step size will affect the iterative efficiency.

In operation S230-4, if a similarity between the current superposed vibration field at each of the one or more target vibration positions and the corresponding target vibration field satisfies the similarity threshold condition, the candidate subset of eigenmodes for the current iteration round may be determined as the subset of eigenmodes for modal superposition.

If S^{p}>S_{threshold} is true (for each target vibration position), indicating that the current superposed vibration field is already close enough to the target vibration field to produce similar localized vibrotactile feedback with a smaller number of eigenmodes, and therefore the plurality of candidate eigenmodes used for superposition to produce the current superposed vibration field may be selected as the eigenmodes ultimately used for superposition.

In order to describe the iterative process more clearly, FIG. 4 shows an algorithmic flowchart associated with the iterative process.

First, in process 1, reference modal participation coefficients corresponding to all eigenmodes aₙ^{r} (e.g., previously determined based on Formula (15)) are determined according to the reference vibration field w^{r} at the target vibration position (shown as 1 in the spatial position grid, here assumed to be 1 target vibration position, but there can be more target vibration positions as described above.), and accordingly the target vibration field (i.e., the target vibration field w^{t}) is determined. This target vibration field is also the vibration field superposed by all modes, which serves as a reference for later structural similarity comparisons, and is therefore also expressed as w⁰. In addition, in this process 1, the initial threshold a_{threshold}^{r0} and the similarity threshold S_{threshold} of the modal participation coefficients are also set.

In process 2, one or more modal participation coefficients greater than the threshold value are selected from all the reference modal participation coefficients aₙ^{r} based on the current modal participation coefficient threshold, and based on the selected one or more modal participation coefficients, corresponding one or more eigenmodes are selected from the set of eigenmodes as a current candidate subset of eigenmodes.

In process 3, based on the selected current candidate subset of eigenmodes and the corresponding reference coefficients, the superposed vibration field w^{p} at the target vibration position is determined.

In process 4, a structural similarity coefficient S^{p} of the currently determined superposed vibration field w^{p} and target vibration field w⁰ (i.e. target vibration field w^{t}) is calculated, and in process 5, the calculated S^{p} is compared with the similarity threshold S_{threshold}.

If S^{p} is greater than the similarity threshold S_{threshold}, indicating that the currently selected subset of eigenmodes is sufficient to generate a satisfactory superposed vibration field, so the driving control information may be determined in process 6 based on the currently selected subset of eigenmodes, for use by the driving circuit to generate driving signals to be applied to the respective vibration components. If SP is not greater than the similarity threshold S_{threshold}, the current modal participation coefficient threshold is adjusted (e.g., decreased) in process 7, e.g., a_{threshold}^{p}=a_{threshold}^{p-1}−δ, and then return to process 2 to re-select a greater number of one or more modal participation coefficients than the previous iteration round that are greater than the threshold from all reference modal participation coefficients aₙ^{r} and continue with the following process.

In summary, through the above iterative process, the number of eigenmodes used can be reduced as much as possible while ensuring that the superposed vibration field at each target vibration position is sufficiently similar to the reference (target) vibration field, thereby reducing the corresponding hardware circuit complexity (such as the number of channels) and design difficulty as well as the algorithm computational load.

Optionally, in combination with the envelope wave modulation as described above, the above process of selecting a smaller number of eigenmodes can also be further combined with the envelope wave modulation. That is, the envelope wave modulation may also be used to modulate at least a part of high-frequency vibration components, included in the superposed vibration field obtained based on the superposition of the selected subset of eigenmodes, into low-frequency envelope waves, frequencies of which are within the tactile sensitive frequency range of the human body that can be perceived, for example, by appropriately selecting and setting various hardware configurations of the vibration plate. In this way, the perceived frequencies can be controlled within the frequency range that the human body can perceive (for example, 50-500 Hz) while achieving localized vibrotactile feedback, and the complexity and difficulty of system design are reduced by algorithm optimization.

An experimental system and experimental verification results of the method for generating localized vibrotactile feedback according to an embodiment of the present application will be described below, thereby better illustrating that the method according to the present application can achieve better effects.

Firstly, the system for generating localized vibrotactile feedback shown in FIG. 1 may be used as an experimental system. First, the vibration plate is selected as a flat plate to simulate a practical plate. This is used as an experimental prototype to excite and verify virtual tactile feedback effect based on the aforementioned method. It should be noted that this experimental prototype is only a carrier for verifying the aforementioned method, the aforementioned methods and algorithms are also feasible when the size and shape of the plate change, the size, number and arrangement of the vibration components (for example, piezoelectric patches) change, and/or the circuit design changes. Next, the experimental system is described in further detail.

The experimental prototype of the vibration plate is a 203*152*1 mm³ glass plate, with a Young's modulus of 72 GPa, a Poisson's ratio of 0.2, and a density of 2500 kg/m³. The vibration components are 6 circular single-layer piezoelectric patches with a diameter of 10 mm, which are evenly attached to edges of the glass plate and used to drive the glass plate to vibrate under the excitation of voltage driving signals, and test the localized vibrotactile feedback effect on the surface of the glass plate (by using laser vibration measurement means). The piezoelectric patches operate in d33 polarization mode (vertical vibration), and drive the glass plate into twisting vibration. In order to better test the surface vibration effect by laser vibration measurement, a layer of white developer was sprayed on the glass plate surface to enhance reflection intensity.

In addition, for the circuit portion, the driving circuit uses a six-channel high-voltage waveform generation circuit (for example, including a waveform generation circuit and a high-voltage amplification circuit). Each channel may realize an output signal of any excitation waveform as a driving signal. Among waveform output parameters, the peak voltage is 140 Vpp, the current is 2 A and the frequency is up to 30 KHz. In addition, the waveform generation circuit may be implemented by FPGA and its related circuits. FPGA obtains the driving control information from the processing means, and then generates six-channel voltage signals, which are amplified by the voltage amplification circuit to output driving signals with waveforms indicated in the driving control information to each piezoelectric patch. The circuit portion further includes a power supply, as shown in FIG. 1. The waveform generation circuit in the driving circuit may generate signals of any desired waveform (10 Vpp).

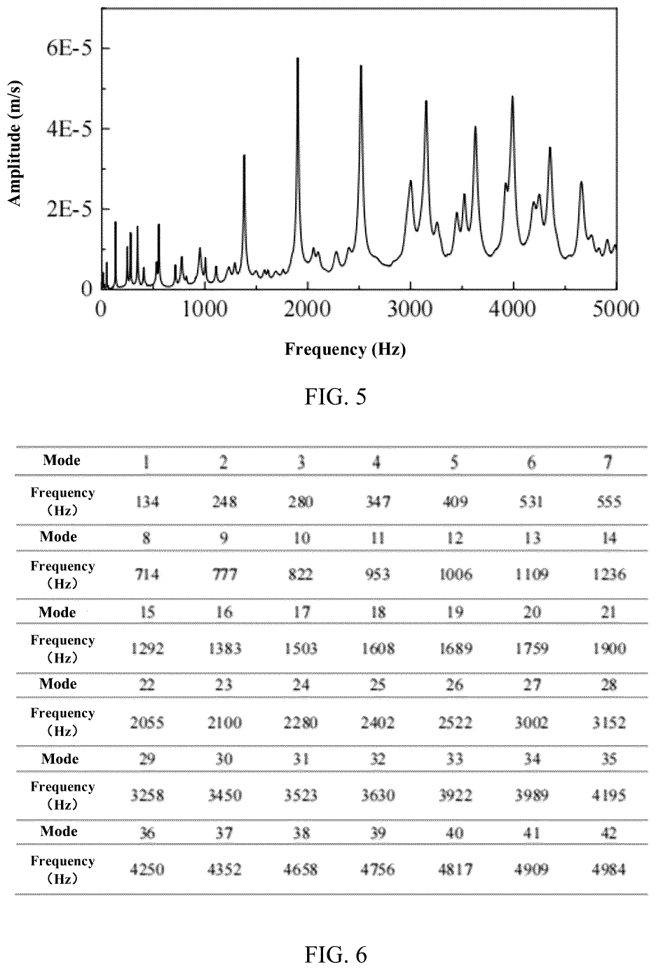

In terms of eigenmode identification, all eigenmodes of the above-mentioned glass plate are obtained by laser vibration measurement means. The laser vibration measurement means may perform laser vibration measurement based on deviation of optical interference and Doppler shift effect, which is known in the art and therefore will not be described herein to avoid obscuring the focus of the present application. The waveform generation circuit may also provide reference signals required for the laser vibration measurement process, and all experimental results (for example, subsequent acquisition of localized vibration patterns) are measured using laser vibration measurement. A frequency response obtained by a laser vibration measurement process during eigenmode identification may be as shown in FIG. 5, where each mode is identified by a peak determination method, that is, there is an eigenmode at each peak. It can be seen that the resonant frequency is within the range of 50-5000 Hz. All modes are lightly damped (attenuation factor <0.01). Forty-two eigenmodes were identified based on the above method, as shown in the table of FIG. 6. It can be seen that a difference between resonant frequencies associated with adjacent eigenmodes is near 100 Hz, which is within the human tactile sensitivity frequency range (50-500 Hz). According to Formula (20), vibrations at these frequency differences can be perceived by the human body. That is, the hardware configuration of the vibration plate selected during the experiment (e.g., boundary conditions, plate width-to-length ratio, and the order number (i,j)) can achieve the effect of envelope wave modulation. That is, when the modal superposition process is required, more higher-order eigenmodes among all eigenmodes may be superposed, while ensuring that frequencies of the superposed vibration field are within the low-frequency range that can be perceived, and this characteristic can be maintained due to shorter wavelengths of the high-frequency vibration components, thus achieving tactile feedback effects with also a higher resolution (smaller area).

Voltage calculation is performed by the processing means, and after all eigenmodes have been identified, all of the eigenmodes are stored as a complex matrix including amplitude and phase information of a corresponding mode shape of each eigenmode. Unlike theoretically vibrations at various discrete positions on the vibration plate either in the same direction (phase 0°) or opposite direction (phase 180°), in experiments or practical applications, phase fields of vibrations at various discrete positions are not binary, but are within the range of [−10°, 10°] or [170°, 190°], and thus need to be described with a complex matrix.

Then, experimental verification results of the method for generating localized vibrotactile feedback according to an embodiment of the present application will be described below.

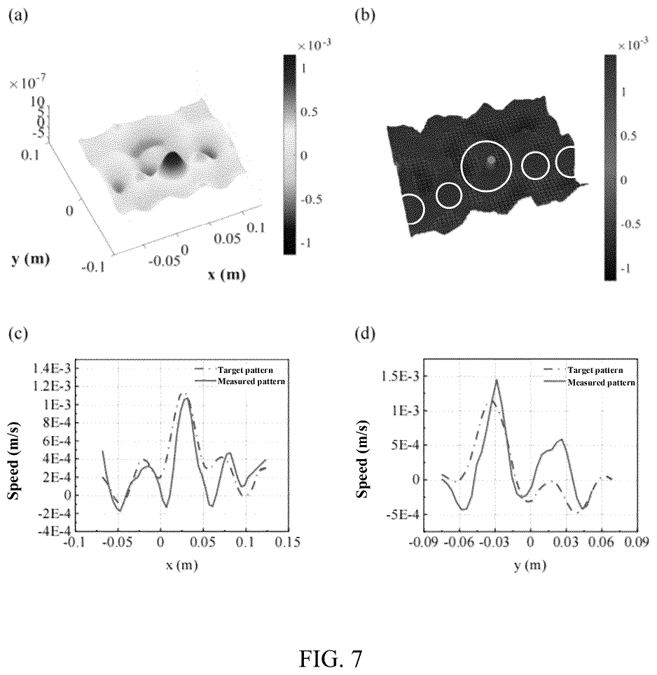

Firstly, the effect of single-point localized vibrotactile feedback is considered. Single-point localized vibration can be realized with only 9 eigenmodes included in the subset of eigenmodes selected by the aforementioned iteration process. The verification results are shown in FIG. 7(a) and FIG. 7(b). FIG. 7(a) shows a designed localized vibrotactile feedback effect as the target, and FIG. 7(b) shows an actual measurement result by a laser vibration measurement process (for illustration, regions with larger amplitudes are shown with white circles in the figure). It can be seen that the two trends are consistent, and vibration is strongest at almost a same target vibration position. It should be noted that due to reduction in the number of modes and modulation of envelope waves, vibrations in other regions are not limited herein except for the target localized vibration regions where the target vibration positions are located. FIGS. 7(c)-7(d) show vibration displacement distributions along the x-direction and γ-direction, respectively, and it can be seen that high-amplitude (characterized by the easier-to-measure vibration speed) regions are as small as 3 cm in diameter, so the resolution is high.

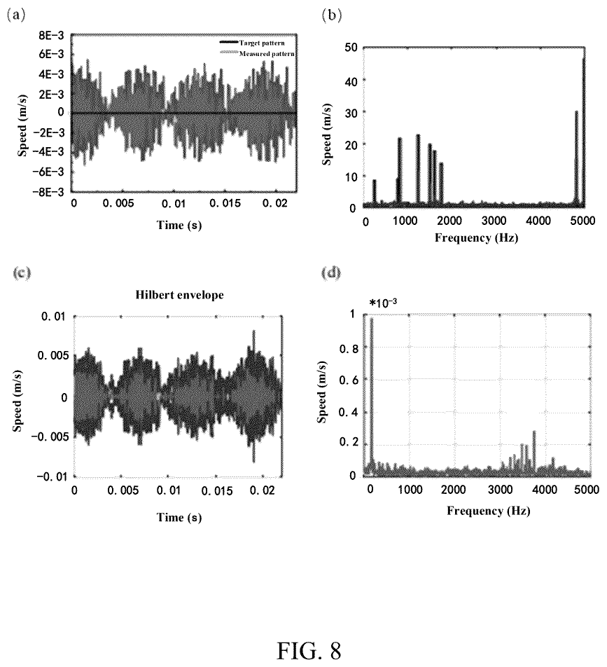

FIG. 8(a) further illustrates speed information of vibration fields at the target vibration positions in FIGS. 7(a)-7(d) (the vibration plate may be divided into multiple regions, one position in each region is used to represent the region, and the target vibration position may be the center position of the region). It can be seen that the curve appears periodic in the time domain space (FIG. 8(a)), and all selected modes in the frequency space are clearly visible (FIG. 8(b)) and consistent with the design. In order to further demonstrate the aforementioned envelope wave modulation, an envelope distribution of the curve is given by using the Hilbert transform (FIG. 8(c)), in which an envelope wave frequency around 170 Hz is clearly visible in the frequency space (FIGS. 8(d)), and 170 Hz is within the most sensitive frequency interval for human tactile perception, so it can be well perceived.

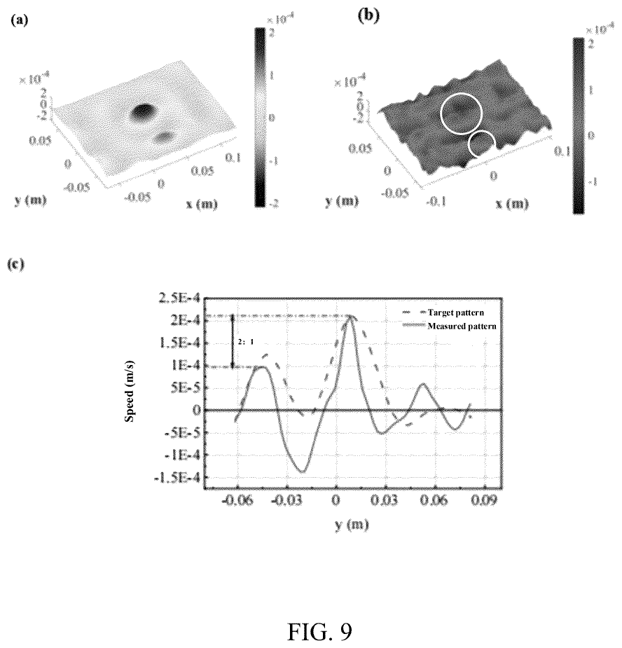

As mentioned previously, the number of target vibration positions may be one or more. Next, the effect when the target vibration position is two will be presented, that is, verification of two-point localized vibrotactile feedback effect. By providing different reference vibration fields, the method of the present application can control an amplitude ratio between different target vibration positions (localized vibration positions). As shown in FIGS. 9(a)-9(c) (for illustration, regions with larger amplitudes are shown with white circles in the figures), two-point localized vibrotactile feedback is designed. Given reference vibration fields at the two target vibration positions, so that localized vibration areas at the two target vibration positions are close, and the amplitude ratio of vibrations at the two target vibration positions is about 2:1 (FIG. 9(a)). Experimental measurement results are shown in FIG. 9(b)-9(c), and the amplitude ratio satisfies 2:1. An advantage of this is that multiple fingers of the human body can perceive different tactile feedback effects.

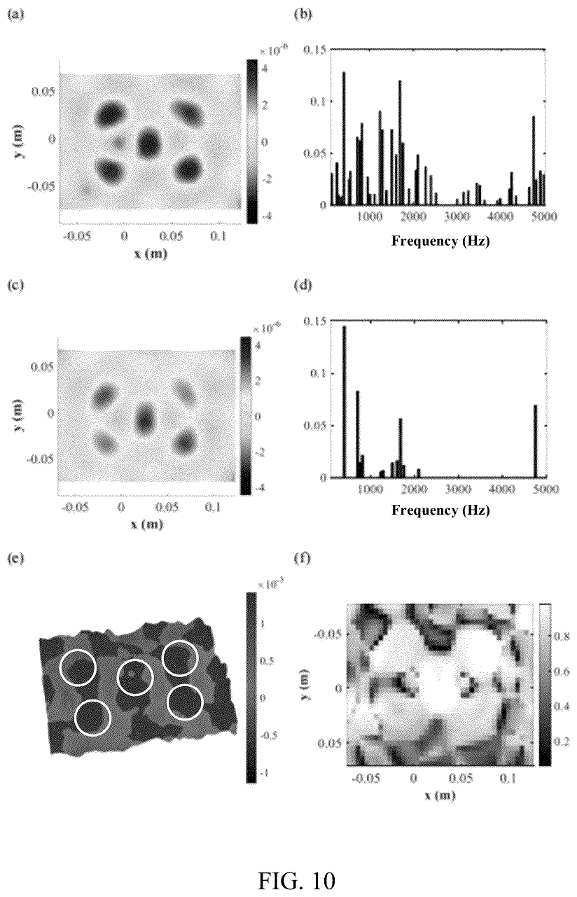

In addition, based on the verification of the two-point localized vibrotactile feedback effect, superiority of the method proposed by the present application in designing more complex multi-point localized vibrotactile patterns is also presented. The method proposed by the present application can effectively reduce the number of eigenmodes used for the requirement of any number of reference vibration fields, while still having acceptable localized vibration pattern quality at each target vibration position (target localized vibration region). FIGS. 10(a)-10(f) illustrate achieving a 5-point tactile feedback effect (for illustration, regions of larger amplitudes are shown with white circles in the figures), where only 10 or so eigenmodes are used, but clear localized vibration modes are still visible. It should be noted that the number of modes may be adjusted according to the need for localized vibration effects. FIGS. 10(a) and 10(c) show calculation results of using all eigenmodes for superposition and using selected partial eigenmodes, respectively, global similarity SSIM of which is greater than 0.4. In contrast, with the method of the present application, the number of adopted eigenmodes can be reduced from 42 (FIGS. 10(b)) to 12 (FIG. 10(d)), greatly reducing the computational load and implementation difficulty of hardware and the system. FIG. 10(e) presents an actual measurement result based on the same experimental prototype, consistent with the design target, where the vibration region is approximately 3.5 cm in diameter. As described above, it is desirable to reduce the number of eigenmodes used for superposition while ensuring the similarity of the results to preset localized vibration targets (peaks) as much as possible. FIG. 10(f) presents localized SSIM, where a 5*5 pixel grid is chosen for each localized region. The calculation result shows that localized SSIM values at five target vibration positions (i.e., structural similarity coefficient values between the target vibration field and the superposed vibration field at each target vibration position) are all as high as 0.9. This shows that the localized vibrotactile feedback effect generated by the method of the present application is highly similar to the localized vibrotactile feedback effect obtained by superimposing all eigenmodes. This also proves that in the case of multi-point localized vibrotactile feedback, the method of the present application can also simplify the circuit and system design under the premise of ensuring the desired multi-point localized vibrotactile feedback effect.

In summary, the method for generating localized vibrotactile feedback proposed by the present application with the corresponding system design can realize localized one-point or multi-point vibrotactile feedback while controlling perceived frequencies within the frequency range that can be better perceived (50 Hz-500 Hz), and reduce the complexity and difficulty of system design.

According to another aspect of the present application, an apparatus for generating localized vibrotactile feedback at a target vibration position of a vibration plate is also provided.

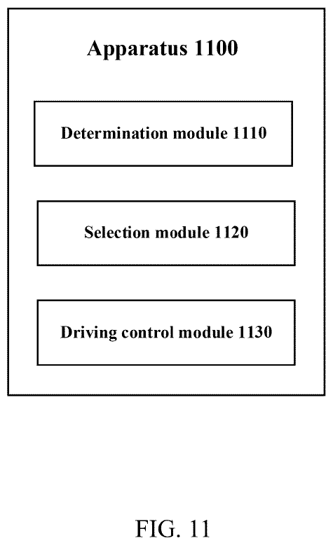

FIG. 11 shows a structural block diagram of an apparatus 1100 for generating localized vibrotactile feedback at a target vibration position of a vibration plate according to an embodiment of the present application.

The apparatus 1100 may include a determination module 1110, a selection module 1120, and a driving control module 1130.

The determination module 1110 may be configured to determine a set of reference modal participation coefficients corresponding to a set of eigenmodes associated with the vibration plate based on the target vibration position and a reference vibration field at the target vibration position, and determine a target vibration field at the target vibration position based on the set of eigenmodes and the set of reference modal participation coefficients.

The selection module 1120 may be configured to select a subset of eigenmodes for modal superposition from the set of eigenmodes and determine a subset of modal participation coefficients corresponding to eigenmodes of the subset of eigenmodes, wherein a superposed vibration field generated based on the subset of eigenmodes and its corresponding subset of modal participation coefficients satisfies a preset similarity requirement with the target vibration field.

The driving control module 1130 may be configured to determine driving control information based on the subset of eigenmodes and its corresponding subset of modal participation coefficients and a position of a vibration component at the vibration plate, wherein the driving control information is used to drive the vibration component to generate the localized vibrotactile feedback at the target vibration position.

Operations performed by the above determination module 1110 may correspond to the contents described above with reference to method steps S210-230 in FIG. 2, operations performed by the selection module 1120 may refer to the contents described in method step S230, and operations performed by the driving control module 1130 may refer to the contents described in method step S240. For more details of operations performed by each module, reference may be made to the foregoing description, and therefore the description will not be repeated herein.

Optionally, the apparatus 1100 may further include other modules, or various modules of the apparatus may be divided in different ways, or may be further divided into more sub-modules. Each module or sub-module may be implemented with dedicated hardware-based systems that perform specified functions or operations (e.g., a general-purpose processor, a digital signal processor (DSP), an application-specific integrated circuit (ASIC), a field programmable gate array (FPGA), or other programmable logic devices, discrete gates or transistor logic devices, discrete hardware components), or may be implemented with a combination of dedicated hardware and computer instructions. For more details of each module, reference may be made to the previous detailed description and will not be repeated herein.

According to another aspect of the present application, a computing device is also provided. The computing device may be processing means as shown in FIG. 1 for executing a method for generating localized vibrotactile feedback at a target vibration position of a vibration plate according to an embodiment of the present application.

As an example, the computing device of the present application may include a processor and a memory connected via a system bus, and may further include a network interface, an input apparatus, a display screen, and the like. The memory includes a non-volatile storage medium and internal memory. The non-volatile storage medium of the computer device stores an operating system and may also store a computer-executable program, which when executed by the processor, causes the processor to implement various operations performed by the computing device as described above. The internal memory may also store a computer-executable program, which when executed by the processor, causes the processor to implement various operations performed by the computing device as described above.

The processor may be an integrated circuit chip with signal processing capabilities. The above-mentioned processor may be a general-purpose processor, a digital signal processor (DSP), an application-specific integrated circuit (ASIC), a field programmable gate array (FPGA) or other programmable logic devices, discrete gates or transistor logic devices, or discrete hardware components, for implementing or executing the disclosed methods, steps and logical block diagrams in the embodiments of the present application. The general-purpose processor may be a microprocessor or the processor may also be any conventional processor and the like, and may be of X84 architecture or ARM architecture.

The non-volatile memory may be a read-only memory (ROM), programmable read-only memory (PROM), erasable programmable read-only memory (EPROM), electrically erasable programmable read-only memory (EEPROM), or flash memory. It should be noted that the memory of the method described herein is intended to include, without being limited to, these and any other suitable categories of memory.

The display screen may be an LCD display screen or an electronic ink display screen, and the input apparatus of the computer device may be a touch layer covered on the display screen, or a button, trackball or touch pad provided on the terminal shell, or an external keyboard, trackpad or mouse, and the like.

It should be noted that the flowcharts and block diagrams in the accompanying drawings illustrate architecture, functions, and operations of possible implementations of methods and apparatus according to various embodiments of the present application. In this regard, each block in the flowcharts or block diagrams may represent a module, a program segment, or a portion of code, which comprises at least one executable instruction for implementing specified logical functions. It should also be noted that, in some alternative implementations, the functions noted in the blocks may occur out of the order illustrated in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, or individual modules mentioned, may be implemented by special purpose hardware-based systems that perform specified functions or operations, or combinations of special purpose hardware and computer instructions.

The embodiments of the present application as described in detail above are illustrative only and not restrictive. It should be understood by those skilled in the art that various modifications and combinations may be made to these embodiments or features thereof without departing from the principles and spirit of the present application, and such modifications should fall within the scope of the present application.

1. A method for generating localized vibrotactile feedback at a target vibration position of a vibration plate, comprising:
determining a set of reference modal participation coefficients corresponding to a set of eigenmodes associated with the vibration plate based on the target vibration position and a reference vibration field at the target vibration position;
determining a target vibration field at the target vibration position based on the set of eigenmodes and the set of reference modal participation coefficients;
selecting a subset of eigenmodes for modal superposition from the set of eigenmodes and determining a subset of modal participation coefficients corresponding to the subset of eigenmodes, wherein a superposed vibration field generated based on the subset of eigenmodes and its corresponding subset of modal participation coefficients satisfies a preset similarity requirement with the target vibration field; and
determining driving control information based on the subset of eigenmodes and its corresponding subset of modal participation coefficients and a position of a vibration component at the vibration plate, wherein the driving control information is used to drive the vibration component to generate the localized vibrotactile feedback at the target vibration position.

2. The method of claim 1, wherein each eigenmode is associated with a respective resonant frequency, and hardware configuration parameters of the vibration plate are set such that a frequency difference between two resonant frequencies associated with every two adjacent eigenmodes in the set of eigenmodes, ordered by frequency values of resonant frequencies, is within a tactile sensitive frequency interval.

3. The method of claim 1, wherein the target vibration position comprises one or more target vibration positions,
wherein selecting the subset of eigenmodes for modal superposition from the set of eigenmodes comprises:
selecting candidate eigenmodes for modal superposition from the set of eigenmodes in increasing numbers in different iteration rounds as candidate subsets of eigenmodes, until an iteration termination condition is reached,
wherein the iteration termination condition comprises that one or more superposed vibration fields at the one or more target vibration positions determined based on a selected candidate subset of eigenmodes in the latest iteration round and its corresponding subset of modal participation coefficients satisfy a similarity threshold condition with corresponding target vibration fields, and wherein satisfying the preset similarity requirement is dependent on satisfying the similarity threshold condition.

4. The method of claim 3, wherein selecting the candidate subsets of eigenmodes from the set of eigenmodes in increasing numbers in different iteration rounds comprises, for each iteration round,
selecting a candidate subset of eigenmodes for a current iteration round from the set of eigenmodes based on the set of reference modal participation coefficients and a current modal participation coefficient threshold condition, and determining a current subset of modal participation coefficients corresponding to the candidate subset of eigenmodes for the current iteration round;
calculating a current superposed vibration field at each of the one or more target vibration positions based on the candidate subset of eigenmodes for the current iteration round and its corresponding current subset of modal participation coefficients;
if a similarity between the current superposed vibration field at at least one target vibration position and a corresponding target vibration field does not satisfy the similarity threshold condition, decreasing the current modal participation coefficient threshold condition for use in a next iteration round; and
if a similarity between the current superposed vibration field at each of the one or more target vibration positions and the corresponding target vibration field satisfies the similarity threshold condition, determining the candidate subset of eigenmodes for the current iteration round as the subset of eigenmodes for modal superposition.

5. The method of claim 4, wherein selecting the candidate subset of eigenmodes for the current iteration round from the set of eigenmodes based on the set of reference modal participation coefficients and the current modal participation coefficient threshold condition comprises:
determining whether each reference modal participation coefficient of the set of reference modal participation coefficients satisfies the current modal participation coefficient threshold condition; and
determining eigenmodes corresponding to reference modal participation coefficients satisfying the current modal participation coefficient threshold condition as the candidate subset of eigenmodes for the current iteration round.

6. The method of claim 4, wherein decreasing the current modal participation coefficient threshold condition comprises decreasing a threshold corresponding to the current modal participation coefficient threshold condition by a predetermined magnitude such that a number of eigenmodes included in a candidate subset of eigenmodes for a subsequent iteration round increases.

7. The method of claim 4, wherein the similarity between the current superposed vibration field and the target vibration field is defined based on a structural similarity index,
the structural similarity index is related to average vibration displacements, standard deviations of vibration displacements, and a similarity of vibration field structures of the two vibration fields.

8. The method of claim 1, wherein the target vibration position is one or more of a preset number of discrete positions on the vibration plate,
wherein the vibration plate is divided into multiple localized vibration regions in rows and columns, and each discrete position of the preset number of discrete positions corresponds to a localized vibration region;
wherein reference vibration fields at the preset number of discrete positions are represented by a reference vibration field matrix, wherein an element in the reference vibration field matrix corresponding to the target vibration position is 1, and elements corresponding to discrete positions other than the target vibration position are 0.

9. The method of claim 8, wherein determining the set of reference modal participation coefficients corresponding to the set of eigenmodes associated with the vibration plate based on the target vibration position and the reference vibration field at the target vibration position comprises:
determining, for each discrete position of the preset number of discrete positions, a vibration field representation at the discrete position based on a measured mode shape of each eigenmode at the discrete position and an unknown modal participation coefficient corresponding to each eigenmode; and
adjusting a value of the modal participation coefficient corresponding to each eigenmode and taking values of respective modal participation coefficients that minimum a sum of differences between the vibration field representation at each discrete position and a corresponding reference vibration field as the set of reference modal participation coefficients.

10. An apparatus for generating localized vibrotactile feedback at a target vibration position of a vibration plate, the apparatus comprising:
a determination module configured to determine a set of reference modal participation coefficients corresponding to a set of eigenmodes associated with the vibration plate based on the target vibration position and a reference vibration field at the target vibration position, and determine a target vibration field at the target vibration position based on the set of eigenmodes and the set of reference modal participation coefficients;
a selection module configured to select a subset of eigenmodes for modal superposition from the set of eigenmodes and determine a subset of modal participation coefficients corresponding to the subset of eigenmodes, wherein a superposed vibration field generated based on the subset of eigenmodes and its corresponding subset of modal participation coefficients satisfies a preset similarity requirement with the target vibration field; and
a driving control module configured to determine driving control information based on the subset of eigenmodes and its corresponding subset of modal participation coefficients and a position of a vibration component at the vibration plate, wherein the driving control information is used to drive the vibration component to generate the localized vibrotactile feedback at the target vibration position.

11. The apparatus of claim 10, wherein each eigenmode is associated with a respective resonant frequency, and hardware configuration parameters of the vibration plate are set such that a frequency difference between two resonant frequencies associated with every two adjacent eigenmodes in the set of eigenmodes, ordered by frequency values of resonant frequencies, is within a tactile sensitive frequency interval.

12. The apparatus of claim 10, wherein the target vibration position comprises one or more target vibration positions,
wherein the selection module, when selecting the subset of eigenmodes for modal superposition from the set of eigenmodes, is configured to:
select candidate eigenmodes for modal superposition from the set of eigenmodes in increasing numbers in different iteration rounds as candidate subsets of eigenmodes, until an iteration termination condition is reached,
wherein the iteration termination condition comprises that one or more superposed vibration fields at the one or more target vibration positions determined based on a selected candidate subset of eigenmodes in the latest iteration round and its corresponding subset of modal participation coefficients satisfy a similarity threshold condition with corresponding target vibration fields, and wherein satisfying the preset similarity requirement is dependent on satisfying the similarity threshold condition.

13. (canceled)

14. A system for generating localized vibrotactile feedback, comprising:
a vibration plate provided with a plurality of vibration components;
laser vibration measurement means for measuring a set of eigenmodes associated with the vibration plate;
processing means for obtaining a reference vibration field at the target vibration position and the set of eigenmodes obtained by the laser vibration measurement means and performing the method of claim 1; and
a driving circuit for generating and outputting a driving signal to drive the plurality of vibration components based on driving control information from the processing means, so that the plurality of vibration components vibrate the vibration plate.

15. The system of claim 14, the driving circuit comprising a waveform generation circuit and a voltage amplification circuit,
the waveform generation circuit generating, based on the driving control information, a multi-channel voltage signal for a plurality of channels having a waveform indicated by the driving control information;
the voltage amplification circuit being used to perform voltage amplification on the multi-channel voltage signal to generate the driving signal for driving the plurality of vibration components.

16. The system of claim 14, wherein the plurality of vibration components is a plurality of piezoelectric patches disposed about the vibration plate.

17. The system of claim 14, wherein hardware configuration parameters of the vibration plate are set such that a frequency difference between two resonant frequencies associated with every two adjacent eigenmodes in the set of eigenmodes, ordered by frequency values of resonant frequencies, is within a tactile sensitive frequency interval.

18. The apparatus of claim 12, wherein the selection module is further configured to, for each iteration round,
select a candidate subset of eigenmodes for a current iteration round from the set of eigenmodes based on the set of reference modal participation coefficients and a current modal participation coefficient threshold condition, and determine a current subset of modal participation coefficients corresponding to the candidate subset of eigenmodes for the current iteration round;
calculate a current superposed vibration field at each of the one or more target vibration positions based on the candidate subset of eigenmodes for the current iteration round and its corresponding current subset of modal participation coefficients;
if a similarity between the current superposed vibration field at at least one target vibration position and a corresponding target vibration field does not satisfy the similarity threshold condition, decrease the current modal participation coefficient threshold condition for use in a next iteration round; and
if a similarity between the current superposed vibration field at each of the one or more target vibration positions and the corresponding target vibration field satisfies the similarity threshold condition, determine the candidate subset of eigenmodes for the current iteration round as the subset of eigenmodes for modal superposition.

19. The apparatus of claim 18, wherein the selection module, when selecting the candidate subset of eigenmodes for the current iteration round from the set of eigenmodes based on the set of reference modal participation coefficients and the current modal participation coefficient threshold condition, is configured to:
determine whether each reference modal participation coefficient of the set of reference modal participation coefficients satisfies the current modal participation coefficient threshold condition; and
determine eigenmodes corresponding to reference modal participation coefficients satisfying the current modal participation coefficient threshold condition as the candidate subset of eigenmodes for the current iteration round.

20. The apparatus of claim 18, wherein the selection module, when decreasing the current modal participation coefficient threshold condition, is configured to decrease a threshold corresponding to the current modal participation coefficient threshold condition by a predetermined magnitude such that a number of eigenmodes included in a candidate subset of eigenmodes for a subsequent iteration round increases.

21. The apparatus of claim 18, wherein the similarity between the current superposed vibration field and the target vibration field is defined based on a structural similarity index,
the structural similarity index is related to average vibration displacements, standard deviations of vibration displacements, and a similarity of vibration field structures of the two vibration fields.
